(19) United States
(12) Patent Application Publication
(10) Pub. No.: US 2004/0146142 A1
(43) Pub. Date: Jul. 29, 2004

(54) Mobile X-ray apparatus

(76) Inventor: Miikka Maijala, Espoo (FI)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 10/353,799

(22) Filed: Jan. 29, 2003

(51) Int. Cl. H05G 1/10

(52) U.S. Cl. 378/102

(57) ABSTRACT

A mobile X-ray apparatus and method for performing X-ray imaging is capable of speeding up the working procedure and, thus, the imaging of the patient. Information provided by a digital sensor for X-ray radiation is provided in a wireless manner directly to a hospital information system or to a data processing device having a wireless connection to the hospital information system.

The present invention relates to a mobile X-ray apparatus, comprising X-ray imaging performance electronics, an X-ray tube assembly for producing X-radiation, said X-ray tube assembly including arm elements and a tube head carried thereby, said tube head being maneuverable for a variety of imaging positions, and X-ray beam receiving elements for receiving the X-radiation produced in the tube head and arriving through an object subjected to imaging.

The apparatus comprises preferably a carriage mobile on wheels having the X-ray imaging performance electronics and X-ray tube assembly integrated therein. The carriage is preferably provided with at least one pair of independently driven drive wheels and motor elements therefor, as well as with a steering handle, such as shown e.g. in FI patent application 991487, wherein the movement of a steering handle is convertible in a relatively simple and reliable manner to an electrical control signal for control electronics of the motor elements.

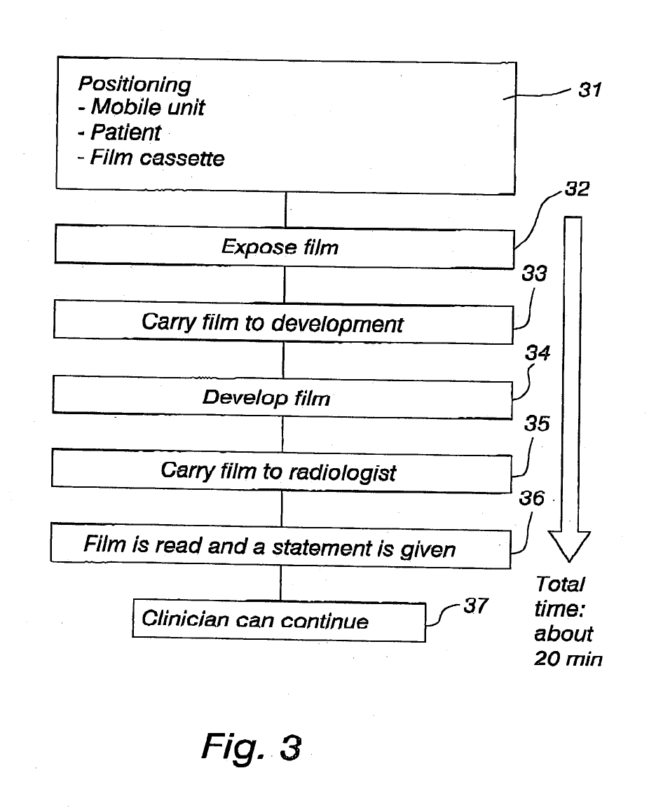

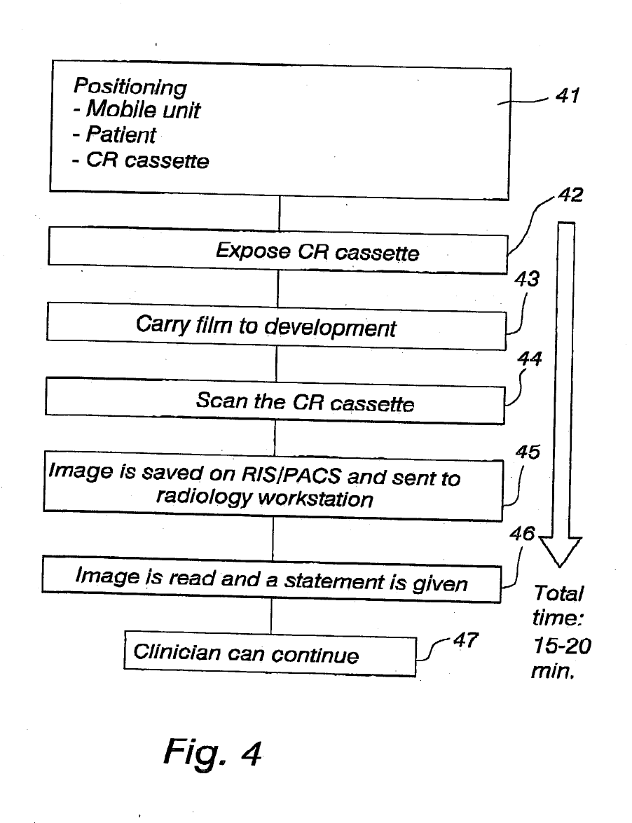

A mobile X-ray apparatus is typically operated in a hospital environment, and especially in the intensive care unit and emergency room. A mobile X-ray apparatus is subject to a number of requirements, which are distinctly different from those set on a stationary X-ray apparatus. Notable examples of requirements placed on a mobile X-ray apparatus include those relating to the size of an imaging area, as well as an ability to endure eventual vibrations and inclinations caused by moving the X-ray unit. When imaging on film or a CR cassette, one problem associated with a mobile X-ray apparatus is slowness in a working procedure. FIG. 3 shows a flowchart for a conventional working procedure in the process of using a mobile X-ray apparatus for images on film. Sequence 31 comprises positioning a mobile X-ray unit, a patient, and a film cassette, followed by sequence 32 for exposing the film. In sequence 33, the film is carried away for development. The film developed in sequence 34 is carried in sequence 35 to a radiologist who studies the images and gives his or her statement (sequence 36). After this, the clinician can continue (sequence 37). This working procedure as a whole takes about 20 minutes. FIG. 4 shows a flowchart for a convention working procedure in the process of using a mobile X-ray apparatus for images on a CR disk (Computed Radiography). Sequence 41 comprises positioning a mobile X-ray unit, a patient, and a film cassette, followed by sequence 42 for exposing the CR disk. As a consequence of X-ray exposure, the atoms of a CR disk will be excited. When the imaging is completed, the CR disk is carried to a CR disk reading device in sequence 43. In the reading device, the X-ray information possessed by the CR disk is read by means of laser beams (sequence 44). Excitation of the atom is discharged by the laser beam. The discharge of excitation results in a release of energy in the form of radiation energy. The releasing radiation energy, i.e. radiation, is detected by means of a detector. When the radiation energy released from all or nearly all of the excited atoms has been detected, the radiation energy information received by the detector contains X-ray information, which can be converted to a digital mode. Image information is saved in sequence 45 in a hospital information system/picture archiving system RIS/PACS (Radiology Information System/Picture Archiving and Communications System) and sent to a radiology workstation. In sequence 46, the image is read and a statement is given regarding the same. After this, the clinician can continue (sequence 47). This working procedure as a whole takes about 15-20 minutes.

It is one important object of the present invention to provide an improved mobile X-ray apparatus capable of speeding up the working procedure and, thus, the treatment of a patient. In order to accomplish this objective, an apparatus of the invention comprises X-ray imaging performance electronics an X-ray tube assembly for producing X-radiation, said X-ray tube assembly including a tube head carried by a support structure, said tube head being maneuverable for a variety of imaging positions, and X-ray beam receiving elements for receiving the X-radiation produced in the tube head and arriving through an object subjected to imaging, said X-ray imaging apparatus comprising, as receiving elements for X-radiation, a digital sensor, whereby information produced by the digital sensor is supplied optionally either to a: date processing device having a wireless connection with a hospital information system or directly to the hospital information system in a wireless manner.

A further object of the present invention is a method for performing X-ray imaging and for processing image information, in which method the X-ray imaging is effected by means of a mobile X-ray apparatus, comprising X-ray imaging performance electronics, an X-ray tube assembly for producing X-radiation, said X-ray tube assembly including a tube head carried by a support structure, said tube head being maneuverable for a variety of Imaging positions, and X-ray beam receiving elements for receiving the X-radiation produced in the tube head and arriving through an object subjected to imaging, said X-ray imaging apparatus comprising, as receiving elements for X-radiation, a digital sensor said method comprising the steps of:

performing the positioning of a mobile X-ray unit, a patient, and a digital sensor, followed by exposure of the patient by X-radiation produced by the X-ray tube assembly, which X-radiation is received by the digital sensor for producing image information,

saving image information thereafter in a hospital information system/picture archiving system in a wireless manner, after which the image information is available for necessary actions. Such actions may include sending the image information to a radiology workstation by means of the RIS system for a radiologist to study and give a statement, the clinician continuing With necessary procedures after receiving said statement.

The invention will now be described with reference to the accompanying drawings, in which:

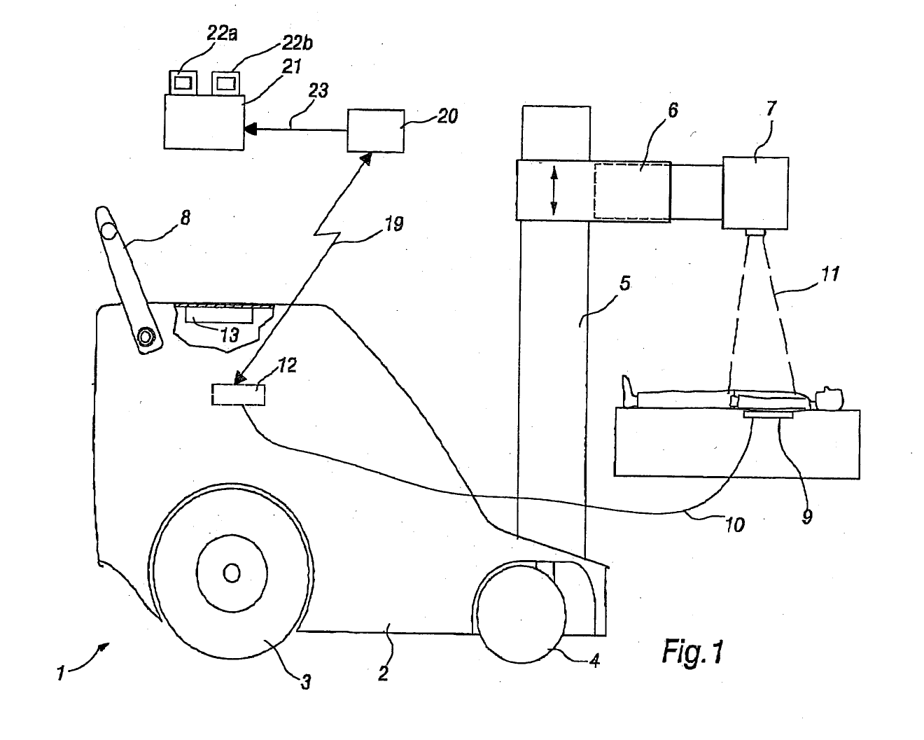

FIG. 1 shows one exemplary embodiment for a mobile X-ray apparatus of the invention in a schematic elevation,

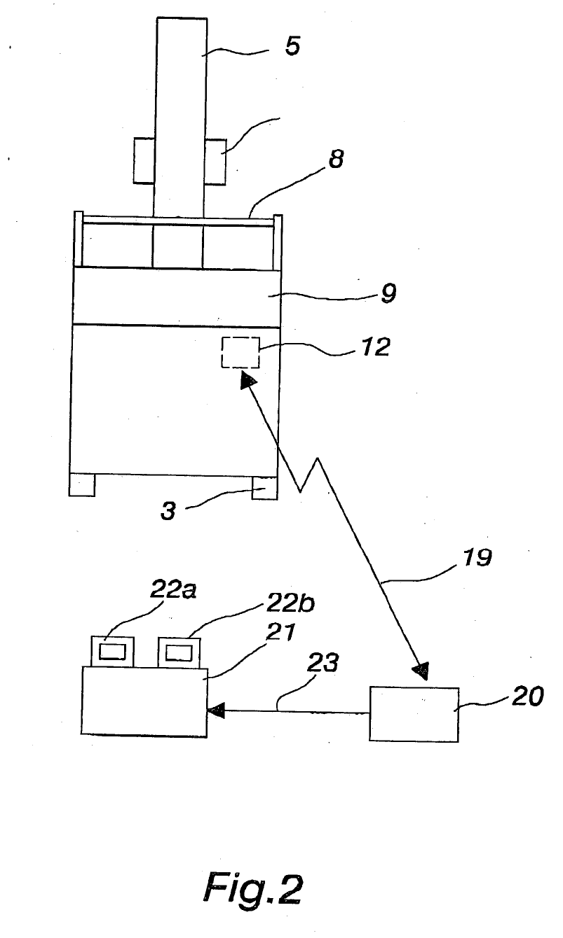

FIG. 2 shows the solution of FIG. 1 in a plan view,

FIG. 3 shows in a flowchart a prior art X-ray imaging process on a film,

FIG. 4 shows in a flowchart a prior art X-ray imaging process on a CR cassette,

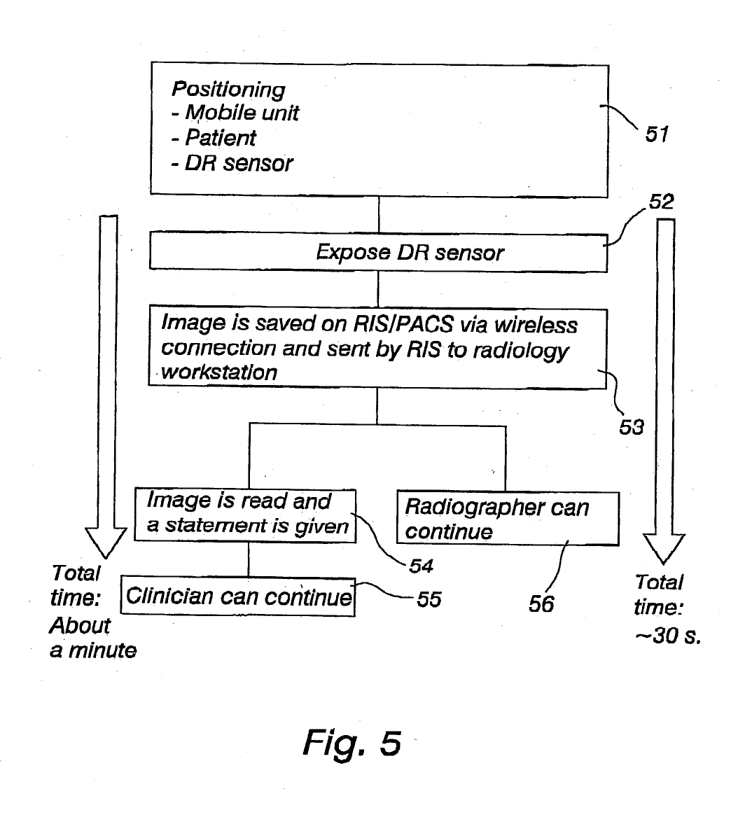

FIG. 5 shows in a flowchart a working procedure with an apparatus of the invention, and

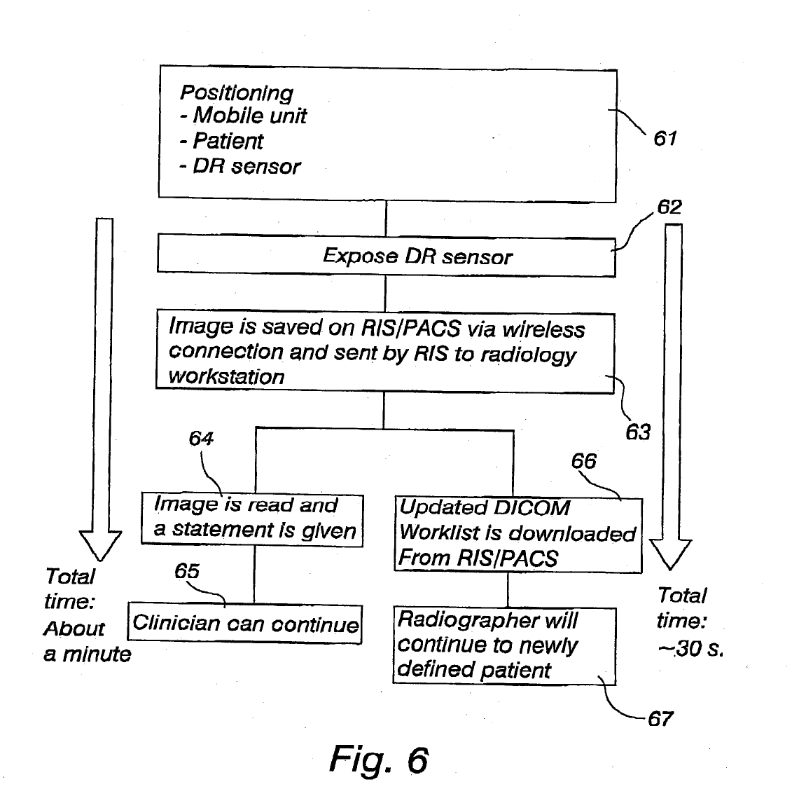

FIG. 6 shows a flowchart similar to FIG. 5, but with a slightly different working procedure,

In reference to FIGS. 1-2, a motor-operated mobile X-ray apparatus 1 comprises a carriage element 2, provided with motor-driven (not shown) drive wheels 3, as well as with steering wheels 4. The drive wheels mounted on either side of the carriage are each preferably provided with a separate drive motor, which are individually controllable. Steering of the carriage is performed by means of a steering handle 8, the drive-wheel motors being operatively controlled by its movements The carriage 2 is provided with an X-ray generator and necessary control electronics for maneuvering the carriage, as well as with imaging performance electronics, which in the illustrated embodiment is implemented by means of a microprocessor 13 shown in a partial cut-away view in FIG. 1. The imaging performance electronics comprises e.g. a software designed for the microprocessor 13, or the imaging performance electronics may be implemented by some other electronic solution. The control electronics required for maneuvering the carriage can also be implemented by means of a software system for the microprocessor 13, or e.g. by means of a programmable logic. Naturally, the carriage may also be designed for a total manual control, without motor elements or control electronics associated therewith, and possibly without batteries, in which case the power required by X-ray imaging is obtained from a mains supply. It is also conceivable to implement the X-ray apparatus without the carriage 2, e.g. as a portable apparatus or as an apparatus provided with a separate carriage.

The carriage 2 is further provided with an X-ray tube assembly for producing X-radiation. Said X-ray tube assembly includes a column 5 pivotable about its vertical axis, a crossarm 6 attached to the column 5, which is capable moving up and down along the column 5, and a tube head 7 mounted on the end of the crossarm 6. The tube head 7 comprises e.g. an X-ray tube, from which the produced X-radiation emanates through an imaged object onto a digital detector 9 placed behind the imaged object. The tube head 7 is preferably articulated to the arm 6 to be pivotable relative to the arm 6 both longitudinally and laterally for setting the tube head in a desired imaging position. The crossarm 6 is preferably a telescopic structure for increasing its lengthwise dimension. The power required by X-ray imaging is obtained either from carriage-mounted batteries or from a mains supply.

The inventive mobile X-ray apparatus includes further a data processing device 12, e.g. a PC, integrated with the carriage element, the detector 9 being connectable thereto by way of a cable 10. The PC 12 is further linked in a wireless manner, as indicated by reference numeral 19, to a server 2U included in a hospital information network, to which is connected, by way of a communication link 23, at least one workstation 21 intended for processing X-ray images and preferably provided with two monitors 22a, 22b. The information network can be immobile or a WLAN network (Wireless Local Area Network). The PC 12 may be located in another place instead of the carriage 2, e.g. in another room, whereby the detector 9 is connected therewith in a wireless manner. The detector 9 may be connected directly to the hospital information system in a wireless manner, whereby the PC 12 may be dispensed with.

For an immobile network, the wireless connection can be established by using e.g. IR (Infrared) technology or RF (Radiofrequency) technology.

In reference to FIG. 5, the working procedure for X-ray imaging in the inventive solution proceeds as follows.

Sequence 51 comprises positioning a mobile X-ray unit, a patient, and a digital sensor, followed by the exposure of a DR (Direct Radiology) sensor in sequence 52. Sequence 53 comprises saving an image in a hospital information system RIS/PACS in a wireless manner and, at the same time, the image information is sent to a radiology workstation by means of the RIS system. After this, the radiographer can continue his or her activities normally (sequence 56). At the same time as the radiographer continues his or her activities, moving to a patient next in line for imaging, the image information is read in the workstation and a statement is given regarding the same (sequence 54), after which the clinician can continue with necessary measures in sequence 55.

In this working procedure, when using the inventive arrangement, the total time for a radiographer will be about 30 seconds and for a clinician about 1 minute. Thus, the inventive solution provides substantial savings in working time and, thus, speeds up a treatment as the image information is immediately available, and there is a further benefit in that the apparatus becomes immediately available for imaging other patients. Savings in working time is especial beneficial when treating premature infants or other patients in a critical state.

In FIG. 6, positioning (sequence 61), exposure of a DR sensor (sequence 60), and saving and sending an image to a radiology workstation (sequence 63) proceed the same way as the corresponding sequences in FIG. 5. Likewise, sequences 64 and 65 are consistent with sequences 54 and 55 in FIG. 5. Sequence 66 is an additional step in the working procedure, wherein the hospital information system RIS/PACS is accessed to download therefrom, preferably In a wireless manner, for the mobile X-ray unit computer an updated worklist, patient information etc., according to which the radiographer can continue to a newly defined patient (sequence 67). Total time in this working procedure of FIG. 6 is substantially equal to what it is in the working procedure of FIG. 5. Said worldist, patient information and other information to be sent to the mobile X-ray is downloaded e.g. from a DICOM (Digital Imaging and Communications in Medicine) system.

1. A mobile X-ray apparatus, comprising X-ray imaging performance electronics, an X-ray tube assembly for producing X-radiation, said X-ray tube assembly including a tube head carried by a support structure, said tube head being maneuverable for a variety of imaging positions, and X-ray beam receiving elements for receiving the X-radiation produced in the tube head and arriving through an object subjected to imaging, said X-ray imaging apparatus comprising, as receiving elements for X-radiation, a digital sensor, whereby information produced by the digital sensor is supplied optionally either to a data processing device having a wireless connection with a hospital information system or directly to the hospital information system in a wireless manner.

2. The apparatus of claim 1, wherein the hospital information system includes a picture archiving and communication system (PACS).

3. The apparatus of claim 1, wherein the apparatus comprises a carriage mobile on wheels having the X-ray imaging performance electronics and X-ray tube assembly integrated therein.

4. A method for performing X-ray imaging and for processing image information, in which method the X-ray imaging is effected by means of a mobile X-ray apparatus, comprising X-ray imaging performance electronics, an X-ray tube assembly for producing X-radiation, said X-ray tube assembly including a tube head carried by a support structure, said tube head being maneuverable for a variety of imaging positions, and X-ray beam receiving elements for receiving the X-radiation produced in the tube head and arriving through an object subjected to imaging, said X-ray imaging apparatus comprising, as receiving elements for X-radiation, a digital sensor said method comprising the steps of:
performing the positioning of a mobile X-ray unit, a patient, and a digital sensor, followed by exposure of the patient by X-radiation produced by the X-ray tube assembly, which X-radiation is received by the digital sensor for producing image information,
saving image information thereafter in a hospital information system/picture archiving system in a wireless manner, after which the image information is available to study and give a statement and/or for other actions.

5. The method of claim 4, wherein information is transferred in a wireless manner from the hospital information system to the mobile X-ray apparatus.
